(19) United States
(12) Patent Application Publication
(10) Pub. No.: US 2015/0065036 A1
(43) Pub. Date: Mar. 5, 2015

(54) NEAR FIELD COMMUNICATIONS FOR TRAFFIC AND HAZARD MAPPING

(71) Applicant: Nokia Corporation, Nokia Group (FI)

(72) Inventor: Arun Srinivasan, San Diego, CA (US)

(73) Assignee: Nokia Corporation, Nokia Group (FI)

(21) Appl. No.: 14/015,563

(22) Filed: Aug. 30, 2013

(51) Int. Cl. H04W 4/02; H04W 4/12; H04B 5/00

(52) U.S. Cl. CPC H04W 4/02; H04B 5/0031; H04W 4/12
USPC 455/41.1

(57) ABSTRACT

Methods and apparatus, including computer program products, are provided for reporting hazards and other events. In one aspect there is provided a method. The method may include receiving, at a user equipment, an indication representative of a selection of a near field communication tag; determining, at the user equipment, an event assigned to the selected near field communication tag; determining a location corresponding to when the selection occurred; and sending, by the user equipment, a message including the event and the determined location. Related apparatus, systems, methods, and articles are also described.

### FIELD

The subject matter described herein relates to navigation.

### BACKGROUND

Navigation systems have become an increasingly common part of vehicles today. Indeed, many smartphones now carry turn-by-turn navigation applications that provide navigation, mapping, and other route information, such as traffic, hazards, and the like. More recently, navigation systems have added crowd-based sources of information. Rather than rely on expert traffic systems, any user can report traffic conditions using the turn-by-turn navigation application. The navigation system may then use the reports to enhance its navigation by providing more up to date, accurate traffic information, and the like.

### SUMMARY

Methods and apparatus, including computer program products, are provided for reporting hazards and other events. In one aspect, there is provided a method. The method may include receiving, at a user equipment, an indication representative of a selection of a near field communication tag; determining, at the user equipment, an event assigned to the selected near field communication tag; determining a location corresponding to when the selection occurred; and sending, by the user equipment, a message including the event and the determined location.

In some variations, one or more of the features disclosed herein including the following features can optionally be included in any feasible combination. The indication may represent a radio frequency signal carrying an identifier for the near field communication tag. The user equipment may further include an application that programmatically sends the message without requiring user access to the application. The application may be at least one of always on and running in a background mode. The near field communication tag may be preconfigured to represent the event. The event may include at least one of a road hazard, a traffic condition, and a mapping error. The near field communication tag may comprise an active near field communication tag including a switch to enable selection. The near field communication tag may be removably affixed to at least one of a dashboard or a steering wheel. The sending may further include sending the message to a server, wherein the server aggregates traffic information from a plurality of user equipment and sends navigation information including alerts to a plurality of user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF THE DRAWINGS

In the drawings,

FIGS. 1A-1B depict example systems for near field communication (NFC) based reporting of events, such as hazards, road conditions, and the like, in accordance with some exemplary embodiments;

FIG. 1C depicts an example of a dashboard including NFC tags, in accordance with some example embodiments;

FIG. 2 depicts an example of a process for near field communication (NFC) based reporting of events, in accordance with some example embodiments;

FIG. 3 depicts an example of a user equipment, in accordance with some example embodiments; and

FIG. 4 depicts an example of a base station, in accordance with some example embodiments.

Like labels are used to refer to same or similar items in the drawings.

### DETAILED DESCRIPTION

Although mapping including navigations systems relying on crowd sourcing have become more prevalent, these systems may require a user to access a smartphone where the navigation system is resident in order to report traffic information. This may present at least two problems. First, it takes time for a user, such as a driver, to pick up the smartphone and report traffic condition. This time represents a hazardous driver distraction. Second, the reporting time actually decreases the accuracy of the reporting. For example, if it takes a driver 1 minute to report the traffic hazard, the reported location of the hazard, when the driver is going 60 miles per hour, may be incorrect by up to 1 mile. In some example embodiments, the subject matter disclosed herein provides near field communication (NFC) tags that can be readily accessed by a user, such as a driver, to report an event, such as a road hazard, traffic conditions, map errors, to a mapping application at a user equipment, such as a wireless device, smart phone, and the like. According to some example embodiments, an event may be referred to as a Point of Interest (POI) on a map or a navigation system. The mapping application may be configured to not require user access to the mapping application in order to report the event to a server. To illustrate by example, a driver encountering a road hazard, such as an object in the road, may select a NFC tag placed within, for example, easy reach of the driver. When selected, the NFC tag sends a radio frequency signal to the mapping application, which programmatically decodes the signal, determines the identity of the NFC tag and its corresponding function (which in this example is road hazard), determines the location when the NFC signal is received, and then reports at least the hazard and its location to a server.

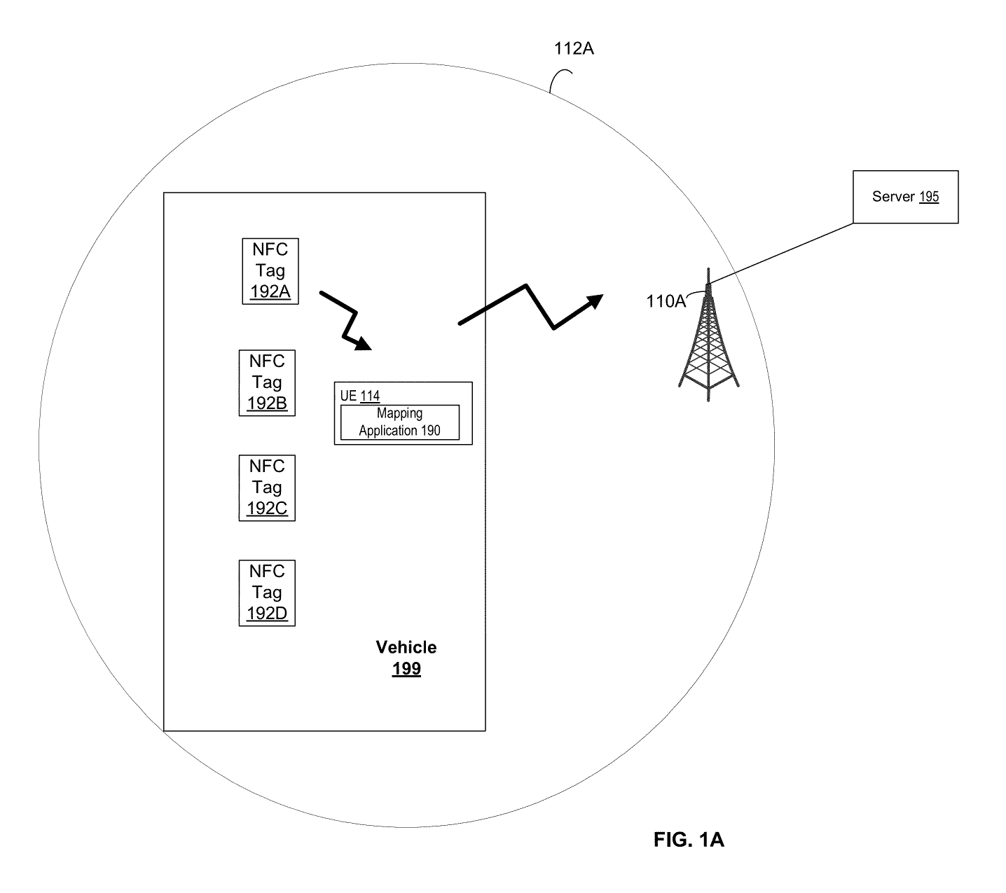

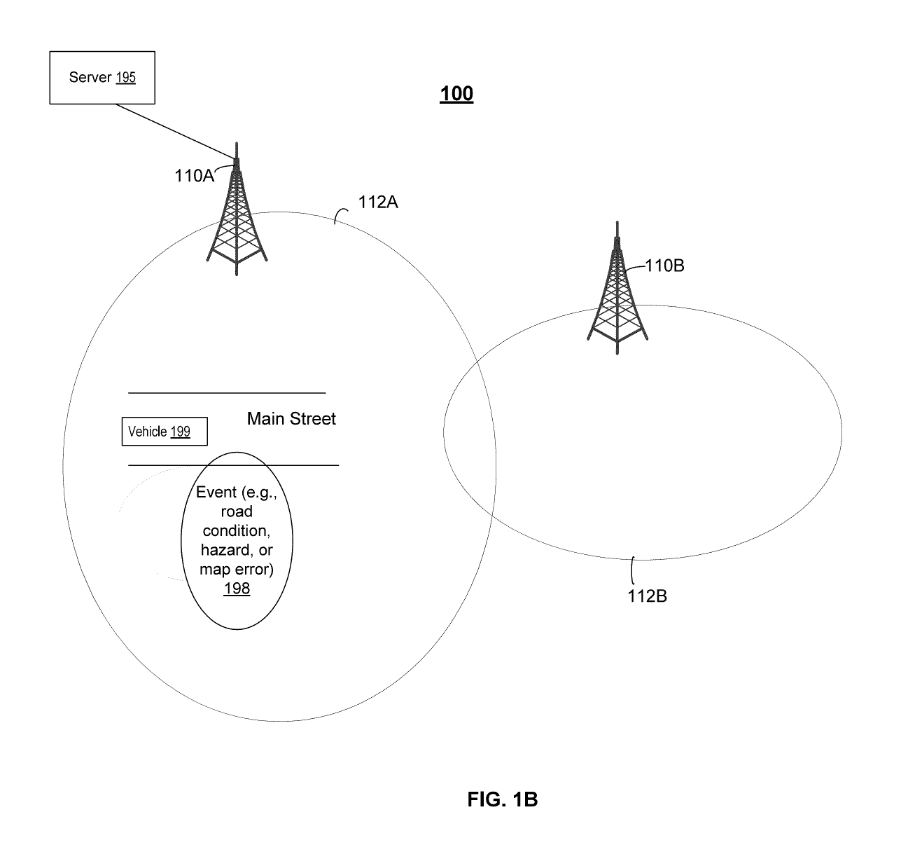

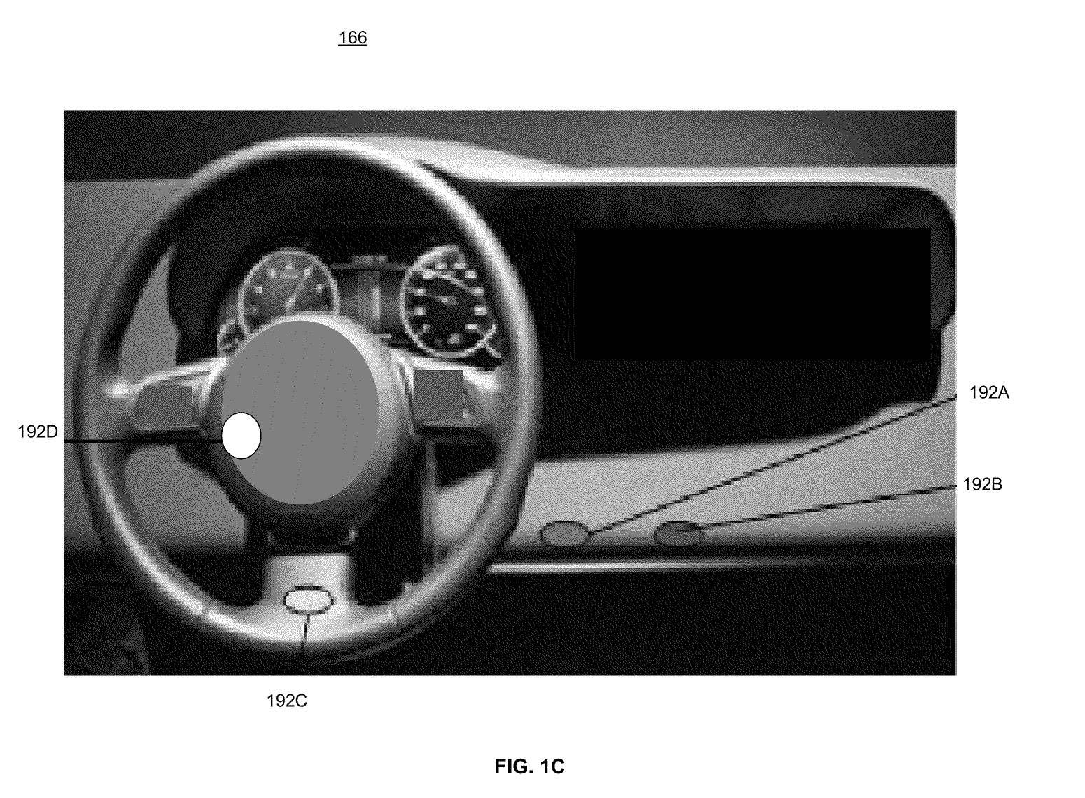

FIG. 1A depicts an example of a system 100 including a vehicle 199 including one or more near field communication (NFC) tags 192A-D and a user equipment 114, which further includes a mapping application 190, in accordance with some example embodiments.

In some example embodiments, each of the NFC tags 192A-D may be associated with a certain event, which may be reported to mapping application 190. Moreover, NFC tags 192A-D may be placed within easy reach of a user, such as a driver, of vehicle 199 (for example, placed on a steering wheel, dashboard, and the like).

To illustrate further, NFC tag 192A may be implemented as a pressure sensitive NFC tag, which when selected (for example, by simply pressing the tag) sends a radio frequency signal identifying that NFC tag 192A has been selected. This NFC signal may be received by user equipment 114 including mapping application 190. The mapping application 190 may determine, based on the received NFC signal, the identity of the selected NFC tag and then determine the type of event corresponding to the NFC tag 192A. For example, mapping application 190 and NFC tag 192A may be configured, so that selecting NFC tag 192A represents a certain event, such as a road hazard. In this example, when NFC tag 192A is selected, the mapping application 190 may decode the received NFC signal to determine the identity of the NFC tag 192A (or source of the NFC signal); determine the associated event, such as the road hazard (which may be pre-programmed or configured by a user); determine a geolocation of the vehicle 190/user equipment 114 when the NFC tag 192A was selected (for example, the corresponding vehicle 190 location as indicated by the mapping application 190 and/or a corresponding positioning/navigation system); and/or report the geolocation of the event/hazard to server 195 via a radio access network 112A served by base station 110A.

In some example embodiments, mapping application 190 may be a mobile application downloaded to user equipment 114, although the mapping application may be provided in other ways as well.

Moreover, the mapping application 190 may, in some example embodiments, be configured to receive the NFC signal and report the location of the vehicle/user equipment, without requiring the user to access user equipment 114 to access, launch, and/or interact with mapping application 190 to report the event. For example, mobile application 190 may be configured as an always-on (or substantially always-on when in motion), run in a background, be part of the operating system of the user equipment, and/or deployed in other ways that does not require a user-driver to, for example, access the user equipment and interact with mobile application in order to report the event.

Although the previous example describes the event as a road hazard, NFC tags 192A-D may be assigned to other events as well including for example, traffic conditions (for example, traffic jams and the like), map errors, construction, road hazards, school zones, police activity, emergency vehicles, children playing, ice or other weather related road conditions, parking availability, and the like. For example, NFC tag 192B may be assigned the function of slow traffic, a traffic jam, and/or the like, so that when a driver encounters a traffic jam on a route being traveled, the driver selects NFC tag 192B. In this example, mapping application 190 may decode the received NFC signal to determine the source NFC tag 192B, determine the associated event, such as traffic jam, determine the location of the vehicle/traffic jam, and report the location of the traffic jam to server 195 via radio access network 112A served by base station 110A.

Another function event that may be assigned is map error. For example, NFC tag 192C may be assigned to report a mapping error to indicate that a mapping or navigation function has an error at a certain location. To illustrate, mapping application 195 may provide navigation instructions, such as turn-by-turn navigation instructions. However, if an error is encountered in the navigation instructions (for example, a turn where no road exists, a turn into oncoming traffic, and the like), a driver may select NFC tag 192C to report the event, which in this case is a map error. When the NFC signal is received by mapping application 190, it may decode the received signal to determine the source NFC tag 192C, determine the associated event/map error, determine the location of the vehicle/map error, and report the location of the map error to server 195 via radio access network 112A served by base station 110A.

Server 195 may receive the reported event (for example, road hazard, traffic jam, map error, and the like) and its corresponding location, and take an appropriate action, such as alert other users in the vicinity/route where the hazard, traffic jam, and/or map error is located. In some example embodiments, the alerts may be sent to a mapping application, such as mapping application 190, to alert the user-drivers. The alert may be an audible alert, such as “you will be approaching a possible road hazard in 500 feet” or “you are approaching a traffic jam,” although the alert may be communicated to the driver in other ways as well including graphically, textually, and the like. In the case of map errors, the server 195 may take further corrective action to ensure that the mapping/navigation information is true (for example, by adding a road to the route database or indication the allowed access to the road).

In some example embodiments, the server 195 may receive reports a plurality of user equipment including mapping applications reporting events, such as road hazards, traffic jams, and map errors. When this is the case, the server 195 may be able to provide enhanced navigation given the breadth of information being provided by different users. Furthermore, the multi-user-provided-information may also be used to confirm the integrity of reported events. For example, when a plurality of user equipment report the same event, the event is more likely to be true. Moreover, if users stop reporting a certain event, that may indicate that the event may have lapsed (for example, the hazard removed, the traffic has subsided, and the like). When the server 195 receives information from a plurality of users, as noted, the users may be considered a “crowd,” and the corresponding aggregate information may represent “crowd sourced” event reporting, which can be used to identify and confirm the presence of events.

FIG. 1B depicts an example of a system 100 but with the addition of an additional radio access network 112B and an event 198. For example, the vehicle 199 may include NFC tags 192A-D placed within easy reach of a user-driver. When a driver detects an event 198, such as a road hazard, a traffic event/traffic jam, a map error, road construction, and the like, the driver may select a corresponding NFC tag 192A-D, which has been preconfigured for the given event. For example, if a driver of vehicle 199 traveling along Main Street sees a sofa in the middle of the road, the driver may select NFC tag 192A, which has been configured to report road hazards. The mobile application 199 may then determine the corresponding event associated with the selected NFC tag 192A signal and report the event along with the current location of vehicle 199 (or user equipment 114/mobile application 190 therein) to server 195.

In some example embodiments, mobile application 190 may, as noted, be configured in a way that does not require the user/driver to access user equipment 114 in order to launch and thus access the mobile application 190. As such, mobile application 190 may be able to promptly report the event to server 195, reducing thus any delays associated with reporting the event. By contrast, if a driver has to access user equipment 114 and manually report the hazard (for example, by unlocking user equipment 114, launching the application, and so forth), a delay may correspond to an error in the reported location of the event/hazard (for example, at 60 miles per hour, a six second delay in reporting represents a location error of 1/10^{th} of a mile). Accordingly, the use of NFC tags 192A-D and mobile application 190 (which does not require access, launch, or other user intervention to report the event) may reduce the reporting delays and increase accuracy, when compared to systems requiring a driver to access the user equipment in order to report the event.

FIG. 1C depicts an example of a dashboard 166 including one or more NFC tags 192A-D, within easy reach of the driver. In some example embodiments, the NFC tags 192A-D are self-stick tags, which can be removably affixed to the dashboard, steering wheel, and other locations in the vehicle, to allow a user-driver to place the NFC tags 192A-D in any location that is within easy reach to the user/driver. In some example embodiments, the NFC tags 192A-D may be prepositioned by, for example, a vehicle manufacturer, in which case the location of the tags is not user/driver configurable. However, the events assigned to each tag may, in some example embodiments, still be configurable by the user/driver.

Although some of the examples described herein refer to a specific quantity of NFC tags, other quantities of NFC tags may be used as well. Moreover, an NFC tag may be assigned more than one event. For example, NFC tag 192A may be configured so that if it is selected once, the NFC signal represents a road hazard but a double-click may represent a traffic jam.

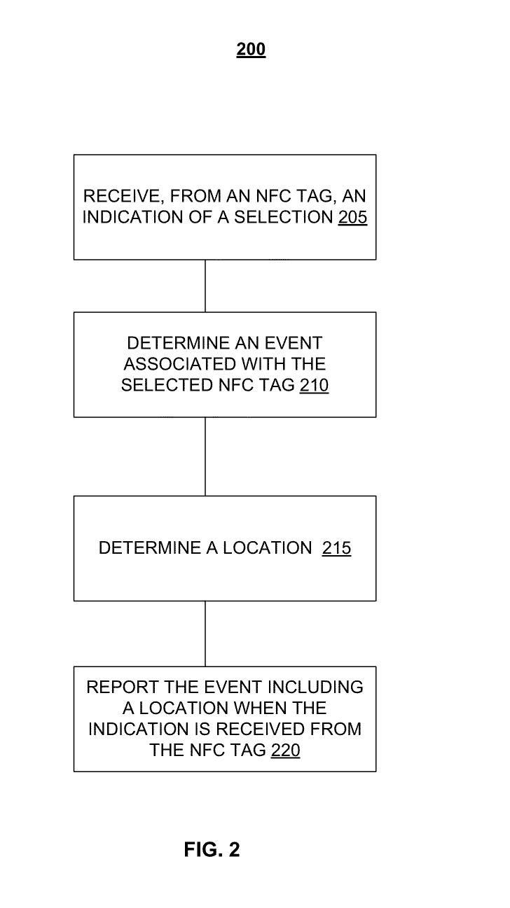

FIG. 2 depicts a process 200 for NFC signaling of mapping events, in accordance with some example embodiments. The description of FIG. 2 also refers to FIG. 1A.

At 205, mobile application 190 may, in some example embodiments, receive a radio frequency signal representative of an indication that an NFC tag has been selected by a user, such as a driver of vehicle 199. For example, an NFC tag may be configured to represent a certain event, such as a road hazard, a traffic condition, a mapping error, and the like. Moreover, the NFC tag may be an active NFC tag including a switch, so that depressing or otherwise selecting the NFC tag causes a radio signal including an identifier of the NFC tag to be transmitted by the NFC tag to the user equipment 114 configured with an NFC transceiver to detect the transmitted NFC signal.

At 210, mobile application 190 may, in some example embodiments, determine an event associated with received signal representative of the selected NFC tag. For example, NFC tags 192A-D may be preconfigured, so that each tag is associated with a certain event. As noted above, NFC tag 192A may be associated with a road hazard, NFC tag 192B may be associated with a traffic jam, and so forth. As such, when the NFC signal is received at 205 and then decoded to determine the identity of the NFC tag that transmitted the NFC signal, the mobile application may determine a corresponding event, such as a road hazard, traffic jam, and the like.

In some example embodiments, a location may be determined, at 215, for the event. For example, when mobile application 190 receives the NFC signal, the mobile application 190 may determine the location of vehicle 199 by, for example, accessing location information from mapping application 190 (or another position or navigation system). This location may provide the location of the vehicle 199, and thus represent the approximate location of the event, such the hazard, traffic jam, and the like. In some example embodiments, the location corresponds to when the NFC signal is received, so that mapping application 190 can determine a location of vehicle 199 at the time of signal receipt. For example, if the NFC signal is received at 0900 hours and 00 seconds, the mapping application may use the vehicle location at 0900:00 as the location of the event. In some example embodiments, the time the NFC signal is received is corrected to adjust for minor delays associated with transmission and processing between the NFC tag and mobile application 190. In any case, the event may be associated with a location and/or a time.

At 220, mobile application 190 may report the event including the location and/or the time to server 190. For example, mobile application 190 may send a message to server 195, and the message may include an event type (for example, road hazard, traffic jam, and the like), a location for the event, and/or a timestamp when the event occurred. The server 195 may then alert the event to other user equipment/mobile applications by sending an alert, such as a message, via base stations/radio access networks. Moreover, server 195 may, in some example embodiments, receive messages from a plurality of user equipment 114 including mobile applications 190 and aggregate the received event information. This crowd-sourced information may, in some example embodiments, provide a greater breadth of event information, which may augment navigation and mapping. Moreover, the crowd-sourced information may, in some example embodiments, improve confidence in the validity and reliability of the information at server 195 and/or provided to user-drivers as alerts.

Referring again to FIG. 1A, user equipment 114 may be referred to as, for example, a mobile station, a mobile unit, a subscriber station, a wireless terminal, a tablet, a smartphone, a wireless device, or the like. The user equipment may be implemented as, for example, a wireless handheld device, a wireless plug-in accessory, or the like.

In the example of FIG. 1A, base stations 110A and 110B may be configured as an evolved Node B (eNB) base station serving macrocells 112A and 112B (also referred to herein as cells and coverage areas). Moreover, when base stations 110A and 110B are implemented as an eNB type base station, as noted above, the base stations may be configured in accordance with standards, including the Long Term Evolution (LTE) standards, such as for example 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base stations 110A and 110B may also be configured to provide other types of air interfaces, such as various first generation (1G) communication protocols, second generation (2G or 2.5G) communication protocols, third-generation (3G) communication protocols, fourth-generation (4G) communication protocols, and/or any other wireless access network communication protocols. Although certain standards and technologies are described, these are merely examples as other standards and technologies may be used as well.

System 100 may include wireless access links. These access links may include downlinks for transmitting to user equipment and an uplink for transmitting from user equipment to a base station. The downlinks and uplinks may each comprise a modulated radio frequency carrying information, such as for example user data (for example, event reports including event type, location, and/or time), control messages, and the like.

Moreover, access points 110A-B may include links, such as for example backhaul links, to other networks (for example, other mobile networks, the Internet, and the like), network nodes, server 195, and the like. Server 195 may be coupled via wireless or wired back haul links (or connections) to a base station, such as base station 110A. Server 195 may include at least one memory including computer program code configured to provide navigation/mapping information, receive crowd sourced event reporting, send alerts to users, and the like.

Although FIGS. 1A-1C depicts specific quantities of devices (for example, a single user equipment, four NFC tags, and so forth), other quantities may be used as well.

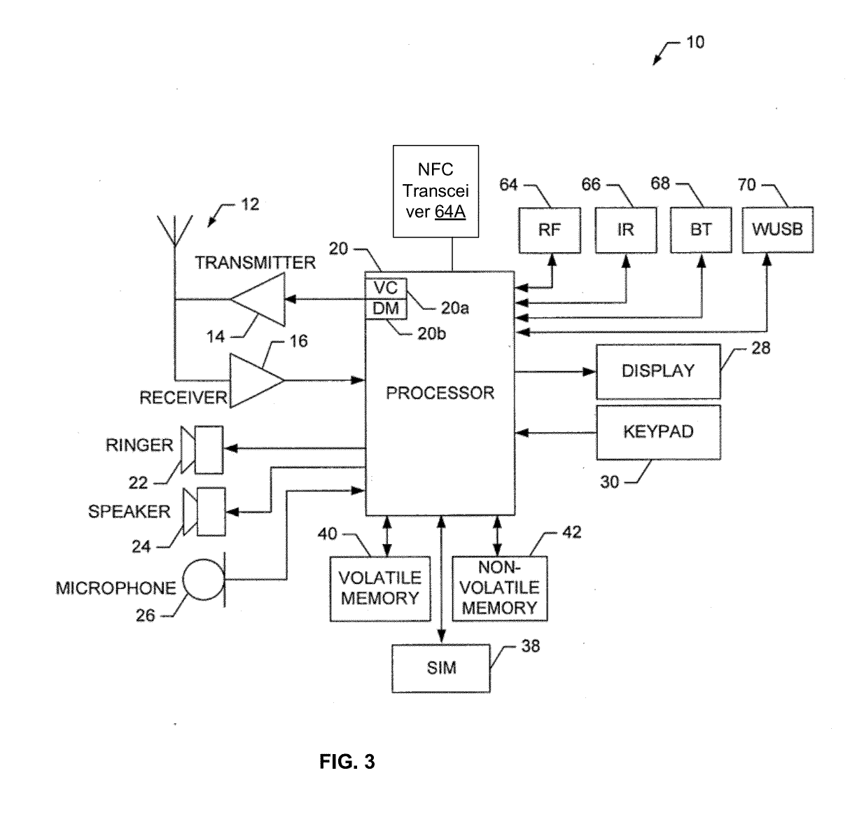

FIG. 3 illustrates a block diagram of an apparatus 10, which can be configured as user equipment, in accordance with some example embodiments.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Apparatus 10 may include a location processor and/or an interface to obtain location information, such as positioning and/or navigation information. Accordingly, although illustrated in FIG. 3 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 3, apparatus 10 may also include one or more mechanisms for sharing and/or obtaining data. For example, the apparatus 10 may include a near field communication radio interface 64A. Moreover, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example within 10 meters. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as for example IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs (for example, mobile application 190), instructions, pieces of information, data, and/or the like which may be used by the apparatus for performing functions of the user equipment/mobile terminal. The memories may comprise an identifier, such as for example an international mobile equipment identification (IMEI) code, capable of uniquely identifying apparatus 10. The functions may include one or more of the operations disclosed herein with respect to the user equipment, such as for example the functions disclosed at process 200. The memories may comprise an identifier, such as for example, an international mobile equipment identification (IMEI) code, capable of uniquely identifying apparatus 10. In the example embodiment, the processor 20 may be configured using computer code stored at memory 40 and/or 42 to receive NFC signals from NFC tags, determine a corresponding event for the selected NFC tag, determine a location corresponding to when the selection occurred, send a message including the event and the determined location, and/or the like as disclosed herein.

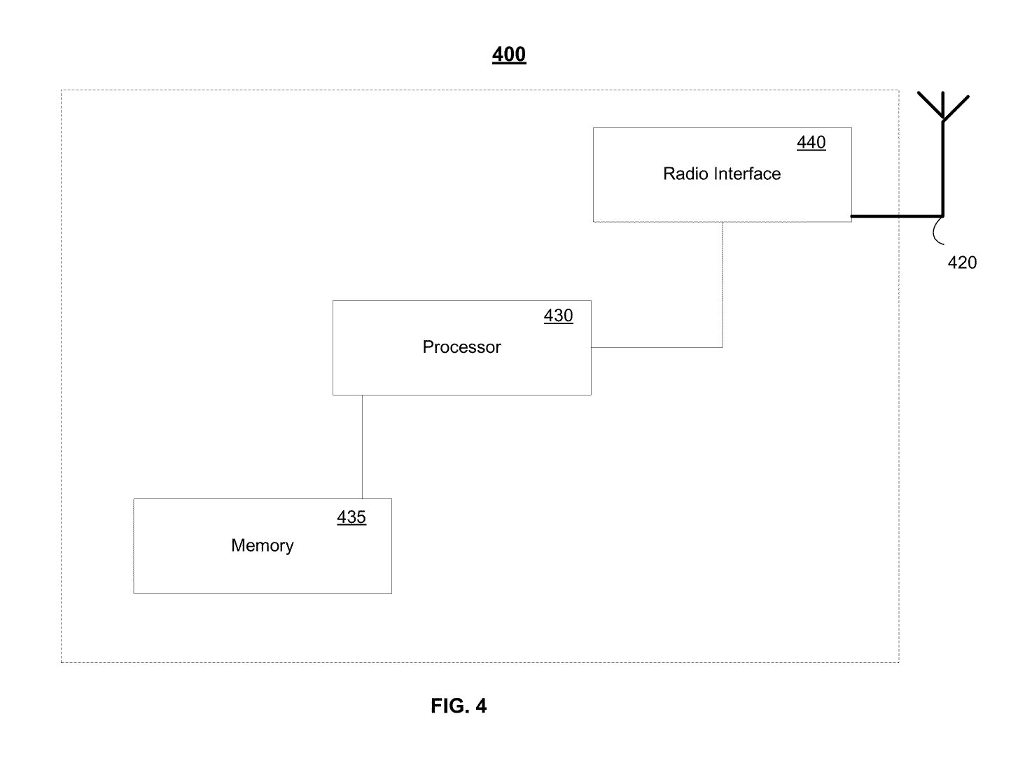

FIG. 4 depicts an example implementation of a network node 400, such as for example a base station and the like. The network node 400 may include one or more antennas 420 configured to transmit via a downlink and configured to receive uplinks via the antenna(s) 420. The network node 400 may include or be coupled to server 195. The network node 400 may further include a plurality of radio interfaces 440 coupled to the antenna 420. The radio interfaces may correspond one or more of the following: Long Term Evolution (LTE, or E-UTRAN), Third Generation (3G, UTRAN, or high-speed packet access (HSPA)), and Global System for Mobile communications (GSM), wireless local area network (WLAN) technology, and any other radio technologies. The radio interface 440 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). The network node 400 may further include one or more processors, such as for example processor 430, for controlling the network node 400 and for accessing and executing program code stored in memory 435. In some example embodiments, memory 435 includes code, which when executed by at least one processor causes one or more of the operations described herein with respect to network node, such as for example a base station, access point, and the like. For example, network node 400 may receive messages from one or more user equipment reporting the location of events, forward messages to a server 195, send alerts to user equipment, and the like.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example a computer or data processor circuitry, with examples depicted at FIGS. 3 and 4. A computer-readable medium may comprise a non-transitory computer-readable storage medium that may be any media that can contain or store the instructions for use by or in connection with an instruction execution system, apparatus, or device, such as for example a computer. Furthermore, some of the embodiments disclosed herein include computer programs configured to cause methods as disclosed herein (see, for example, process 200 and/or the like).

Without in any way limiting the scope, interpretation, or application of the claims appearing below, a technical effect of one or more of the example embodiments disclosed herein is providing more precise location information to a navigation information server.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

What is claimed:

1. A method comprising:
receiving, at a user equipment, an indication representative of a selection of a near field communication tag;
determining, at the user equipment, an event assigned to the selected near field communication tag;
determining a location corresponding to when the selection occurred; and
sending, by the user equipment, a message including the event and the determined location.

2. The method of claim 1, wherein the indication represents a radio frequency signal carrying an identifier for the near field communication tag.

3. The method of claim 1, wherein the user equipment further comprises an application that programmatically sends the message without requiring user access to the application.

4. The method of claim 3, wherein the application is at least one of always on and running in a background mode.

5. The method of claim 1, wherein the near field communication tag is preconfigured to represent the event.

6. The method of claim 1, wherein the event comprises at least one of a road hazard, a traffic condition, and a mapping error.

7. The method of claim 1, wherein the near field communication tag comprises an active near field communication tag including a switch to enable selection.

8. The method of claim 1, wherein the near field communication tag may be removably affixed to at least one of a dashboard or a steering wheel.

9. The method of claim 1, wherein the sending further comprises:
sending the message to a server, wherein the server aggregates traffic information from a plurality of user equipment and sends navigation information including alerts to a plurality of user equipment.

10. An apparatus comprising:
at least one processor; and
at least one memory including computer program code, the at least one processor, the at least one memory, and the computer program code configured to cause the apparatus to at least:
receive, at the apparatus, an indication representative of a selection of a near field communication tag;
determine, at the apparatus, an event assigned to the selected near field communication tag;
determine a location corresponding to when the selection occurred; and
send, by the apparatus, a message including the event and the determined location.

11. The apparatus of claim 10, wherein the indication represents a radio frequency signal carrying an identifier for the near field communication tag.

12. The apparatus of claim 10, wherein the apparatus further includes an application that programmatically sends the message without requiring user access to the application.

13. The apparatus of claim 12, wherein the application is at least one of always on and running in a background mode.

14. The apparatus of claim 10, wherein the near field communication tag is preconfigured to represent the event.

15. The apparatus of claim 10, wherein the event comprises at least one of a road hazard, a traffic condition, and a mapping error.

16. The apparatus of claim 10, wherein the near field communication tag comprises an active near field communication tag including a switch to enable selection.

17. The apparatus of claim 10, wherein the near field communication tag may be removably affixed to at least one of a dashboard or a steering wheel.

18. The apparatus of claim 10, wherein the apparatus is further configured to at least send the message to a server, wherein the server aggregates traffic information from a plurality of apparatus and sends navigation information including alerts to a plurality of apparatus.

19. A non-transitory computer-readable storage medium including code which when executed by at least one processor cause operations comprising:
receiving an indication representative of a selection of a near field communication tag;
determining an event assigned to the selected near field communication tag;
determining a location corresponding to when the selection occurred; and
sending a message including the event and the determined location.
